(19) United States
(12) Patent Application Publication
(10) Pub. No.: US 2013/0344394 A1
(43) Pub. Date: Dec. 26, 2013

(54) TIN CARBON COMPOSITE, METHOD FOR PREPARING SAME, BATTERY NEGATIVE ELECTRODE COMPONENT COMPRISING SAME, AND BATTERY HAVING THE NEGATIVE ELECTRODE COMPONENT

(71) Applicants: Li Yang, Shanghai (CN); Jizhang Chen, Shanghai (CN); Shaohua Fang, Shanghai (CN)

(72) Inventors: Li Yang, Shanghai (CN); Jizhang Chen, Shanghai (CN); Shaohua Fang, Shanghai (CN)

(73) Assignees: SHANGHAI JIAO TONG UNIVERSITY, Shanghai (CN); TOYOTA JIDOSHA KABUSHIKI KAISHA, Toyota-shi, Aichi-Ken (JP)

(21) Appl. No.: 14/003,132

(22) PCT Filed: Mar. 8, 2012
(86) PCT No.: PCT/CN2012/072098

§ 371 Date: Sep. 4, 2013

(30) Foreign Application Priority Data
Mar. 10, 2011 (CN) 201110068960.8

(51) Int. Cl. H01M 4/36; H01M 4/04

(52) U.S. Cl. CPC H01M 4/366; H01M 4/04
USPC 429/231.8; 264/29.1

(57) ABSTRACT

Disclosed is a tin-carbon mesoporous composite for a lithium ion battery negative electrode material, and a method for preparing the same. Using a mesoporous molecular sieve as a template, the precursors of tin and carbon are caused to fill the mesopores of the template and carbonized under nitrogen to obtain a composite of stannic oxide and carbon, and the stannic oxide is encapsulated by the carbon; and then the tin-carbon mesoporous composite for lithium ion battery negative electrode material is obtained by hydrothermal treatment, carbonization, etching, and high temperature carbothermic reduction. The tin-carbon mesoporous composite for lithium ion battery negative electrode material synthesized in the present invention has a reversible capacity of 550 mAh·g⁻¹, after 100 cycles at a current density of 500 mA·g⁻¹.

### TECHNICAL FIELD

The present invention relates to a tin-carbon composite, a method for producing the same, a battery negative electrode material comprising the composite, and a battery having the negative electrode material.

### PRIOR ART

Metallic tin is known as a material for the negative electrode of lithium ion batteries that has characteristics such as high specific capacity, high density, safety, environmental friendliness, and low cost. At present, although the specific capacity of commercialized graphite negative electrode materials is 372 mAh·g⁻¹ or 833 mAh·cm⁻³, the specific capacity of tin is as high as 993 mAh·g⁻¹ or 7313 mAh·cm⁻³. However, since the volume of tin rapidly expands or shrinks in the charge and discharge process to cause a powdering phenomenon, the contact of active materials with current collectors is lost to cause a significant reduction in capacity. At present, the research on metallic tin for a negative electrode material focuses attention on the following two points. The first point is to introduce other metal to thereby form an inactive/active metal alloy material. Examples of these inactive/active metal alloy materials include Cu₆Sn₅, CoSn₃, Ni₃Sn₄, and FeSn₂. The second point is to disperse tin nanoparticles in a carbon-based material to thereby reduce the change of volume in the charge and discharge process.

At present, examples of the method for producing a tin/carbon composite for a lithium ion battery negative electrode material mainly include carbothermic reduction, electrospinning, electroplating, chemical plating, and liquid phase reduction.

CN101723315A discloses an amorphous carbon ball-covered nano-tin material obtained by a hydrothermal method performed twice and one-step carbothermic reduction as a Sn/C nano composite material with a core/shell structure. This production method has an advantage of not using an expensive and dangerous reducing agent, but the shape of the product is irregular. Further, the dispersed nanoparticles have too high surface reaction activity, low thermodynamic stability, and are easily aggregated. Application of the material is therefore difficult.

Journal of Power Sources 195 (2010) 1216-1220 discloses a fibrous Sn/C thin film produced by an electrospinning method. In this material, fine tin nanoparticles are uniformly dispersed in amorphous carbon, and the material has a reversible specific capacity of 382 mAh·g⁻1 after 20 cycles are performed at a current density of 0.5 mA·cm⁻². However, the product obtained by this method is easily oxidized and cannot be stored in the air for a long period of time because a part of the tin is exposed to the outside of the carbon.

Journal of Applied Electrochemistry 39 (2009) 1323-1330 discloses a Cu₆Sn₅ alloy material produced by a one-step electrolytic deposition method from roughened copper foil. This method is simple in operation, but since the resulting product has a large particle size and the volume change of metallic tin in the charge and discharge process cannot be reduced, its electrochemical performance is low.

ACS Applied Materials & Interfaces 2 (2010) 1548-1551 discloses an alloy metallic material series produced in a tetraethylene glycol solution using NaBH₄ as a reducing agent. Among these, FeSn₂ shows the best cycle performance, and its capacity after 15 cycles are performed at a magnification of 0.05C is stable at 480 mAh·g^{·1}. However, when this method is employed, it will be high in cost and poor in electrochemical performance.

### SUMMARY OF THE INVENTION

An object of the present invention is to provide a tin/carbon composite having excellent electrochemical performance, a method for producing the same, a battery negative electrode component comprising the composite, and a battery.

Firstly, the present invention provides a tin-carbon composite that has mesopores.

The mesopores are preferably formed as a honeycomb structure.

The pore size of the mesopores is preferably 30 nm or less.

The particle size of tin is preferably three times or less of the mesopore size.

Secondly, the present invention provides a method for producing a tin-carbon composite having mesopores. The method includes: providing a mesoporous molecular sieve as a template; filling mesopores of the template with a stannous halide and a soluble resole resin having a molecular weight of 300 to 500 followed by carbonization in an inert gas atmosphere to obtain a stannic oxide/carbon composite in which the stannic oxide is covered with the carbon; subjecting the resulting composite to hydrothermal treatment in a polyhydroxy aldehyde solution, separation, washing, and drying followed by carbonization again to cover the stannic oxide nanoparticles exposed to the outside of the carbon in the mesopores and cover the external surface of the mesoporous molecular sieve with one layer of carbon; removing the template with an alkaline solution; and reducing the stannic oxide to metallic tin by high-temperature treatment to obtain a tin-carbon composite having mesopores.

The stannous halide, the soluble resole resin, and the mesoporous molecular sieve are preferably mixed in a weight ratio of 1:0.5 to 5:0.5 to 5.

Thirdly, the present invention provides a lithium ion battery negative electrode component that has a tin-carbon composite having mesopores.

Fourthly, the present invention provides a lithium ion battery having the negative electrode component in the above third aspect.

In the method for producing a tin-carbon composite in the present invention, a mesoporous molecular sieve is used as a template to thereby fill the mesopores of the template with low-cost tin precursor and carbon precursor. Therefore, aggregation of the precursors in a heat treatment process is avoided, and a tin/carbon mesoporous composite in which tin is completely covered with carbon is obtained by post treatment. The present invention solves the problems in other synthesis methods, which are the difficulties to produce fine metallic tin nanoparticles, to uniformly and completely cover tin with carbon, and to obtain a tin/carbon composite having a high specific surface area. Further, since the tin-carbon composite having mesopores produced in the present invention has a nano/micro hierarchical structure, there is no disadvantages of high interface reaction activity, low thermodynamic stability, and ease of aggregation of the nanoparticles. When the tin-carbon composite having mesopores in the present invention is used for a lithium ion battery negative electrode material, the mesopores and a fine particle size provides advantages in the transfer and diffusion of lithium ions and electrons; the volume change in the charge and discharge process can be efficiently relieved, and the powdering phenomenon is suppressed. Therefore, battery cycle performance is excellent.

According to a preferred example of the present invention, a tin/carbon mesoporous composite having a particle size of only 5 to 8 nm is obtained. Further, when the tin/carbon mesoporous composite of the present invention is used for a lithium ion battery negative electrode material, it has a reversible capacity of 550 mAh·g⁻¹ after 100 cycles are performed at a current density of 500 mA·⁻¹.

### BRIEF DESCRIPTION OF THE DRAWINGS

FIG. 1 is a transmission electron microscope photograph of a tin/carbon mesoporous composite for the negative electrode material for a lithium ion battery obtained in Example 1;

FIG. 2 shows wide-angle and small-angle X-ray diffraction patterns of the tin/carbon mesoporous composite for the negative electrode material for a lithium ion battery obtained in Example 1;

FIG. 3 is a diagram showing a nitrogen adsorption curve of the tin/carbon mesoporous composite for the negative electrode material for a lithium ion battery obtained in Example 1; and

FIG. 4 is a diagram of the cycle characteristics of a lithium ion battery assembled using, as an electrode material, the tin/carbon mesoporous composite for the negative electrode material for a lithium ion battery obtained in Example 1.

### BEST MODE FOR CARRYING OUT THE INVENTION

A specific method for producing a tin-carbon composite having mesopores of the present invention is as follows.

A stannous halide in an amount of 1 part by weight and 0.5 to 5 parts by weight of a soluble resole resin having a molecular weight of 300 to 500 are dissolved in 5 to 20 parts by weight of an organic solvent, and then thereto is added 0.5 to 5 parts by weight of a mesoporous molecular sieve. The resulting mixture is stirred for 0.5 to 5 h, dried, and then heat-treated at 350 to 600° C. for 2 to 6 h in an inert gas atmosphere. Then, the heat-treated mixture is dispersed in 10 to 50 parts by weight of a 0.1 to 0.5 mol/L aqueous polyhydroxy aldehyde solution, subjected to hydrothermal treatment at 160 to 200° C. for 2 to 6 h, subjected to centrifugal separation, washing, and drying, and then heat-treated at 350 to 600° C. for 2 to 6 h in an inert gas atmosphere. Then, the heat-treated material is dispersed in 10 to 500 parts by weight of a 0.5 to 5 mol/L aqueous alkaline solution, stirred for 6 to 24 h, and subjected to separation, washing, and drying. Then, the dried material is heat-treated at 650° C. or more for 2 to 6 h in an inert gas atmosphere to thereby obtain a tin/carbon mesoporous composite.

Stannous chloride, stanous bromide, and the like can be used as the stannous halide.

A mesoporous molecular sieve SBA-15, a mesoporous molecular sieve KIT-6, a mesoporous molecular sieve MCM-41, and the like can be used as the above mesoporous molecular sieve.

Alcohol, tetrahydrofuran, ethyleneglycol dimethyl ether, and the like can be used as the above organic solvent.

Nitrogen, argon, and the like can be used as the above inert gas.

An aqueous glucose solution, an aqueous sucrose solution, and the like can be used as the above aqueous polyhydroxy aldehyde solution.

A solution of sodium hydroxide, potassium hydroxide, or the like can be used as the above alkaline solution.

In the obtained tin/carbon mesoporous composite, the pore size of mesopores is 2 nm or more and 50 nm or less, preferably 30 nm or less, more preferably 20 nm or less, and further preferably 15 nm or less. If the pore size of mesopores is too large, the structure will easily collapse.

In the obtained tin/carbon mesoporous composite, the particle size of tin is three times or less, preferably two times or less, and more preferably 1.5 times or less the mesopore size. If the particle size of tin is too large, the structure of powder will collapse because it will be too large when tin expands as lithium enters the mespores.

The obtained tin/carbon mesoporous composite has a regular mesoporous structure. That is, the mesopores in the tin/carbon mesoporous composite are formed in a honeycomb shape.

The method for producing a soluble resole resin having a molecular weight of 300 to 500 to be used in the following example is as follows. Specifically, 11 g of phenol, 0.46 g of sodium hydroxide, and 18.9 g of a 40 wt. % formalin solution are mixed, stirred at 75° C. for 1 h, and cooled to room temperature, and then thereto is added a 1.0 mol/L hydrochloric acid solution until a pH =7 is obtained. The mixture is dried at 50° C. for 12 h in a vacuum atmosphere.

The method for producing a mesoporous molecular sieve SBA-15 to be used in the following example is as follows. Specifically, 4 g of a nonionic surfactant P123 (EO₂₀PO₇₀EO₂₀, Mw=5800, Aldrich), 125 mL of deionized water, 17 mL of 35 wt. % concentrated hydrochloric acid, and 9 mL of tetraethyl orthosilicate are mixed and stirred at 40° C. for 24 h. The mixture is then subjected to hydrothermal treatment at 100° C. for 24 h, subjected to centrifugal separation and drying, and then heat-treated at 550° C. for 6 h.

However, methods for producing the soluble resole resin and the mesoporous molecular sieve SBA-15 used in the present invention are not limited to these methods, but they can be produced by any conventionally known method, and commercially available products can also be used.

### Example 1

In 6 g of tetrahydrofuran, were dissolved 0.6 g of stannous chloride and 0.6 g of a soluble resole resin having a molecular weight of 300 to 500. Then, 0.4 g of a mesoporous molecular sieve SBA-15 was added thereto. The mixture was stirred for 1 h, dried, and then heat-treated at 500° C. for 4 h in a nitrogen gas atmosphere. The heat-treated material was dispersed in 20 mL of a 0.2 mol/L aqueous glucose solution.

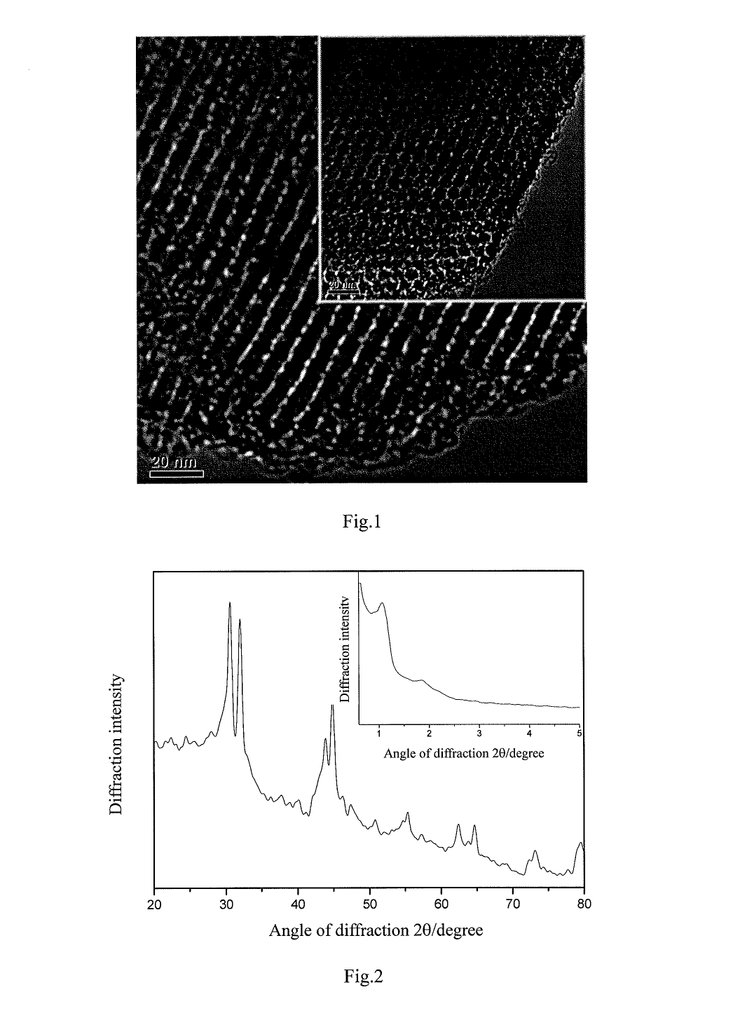

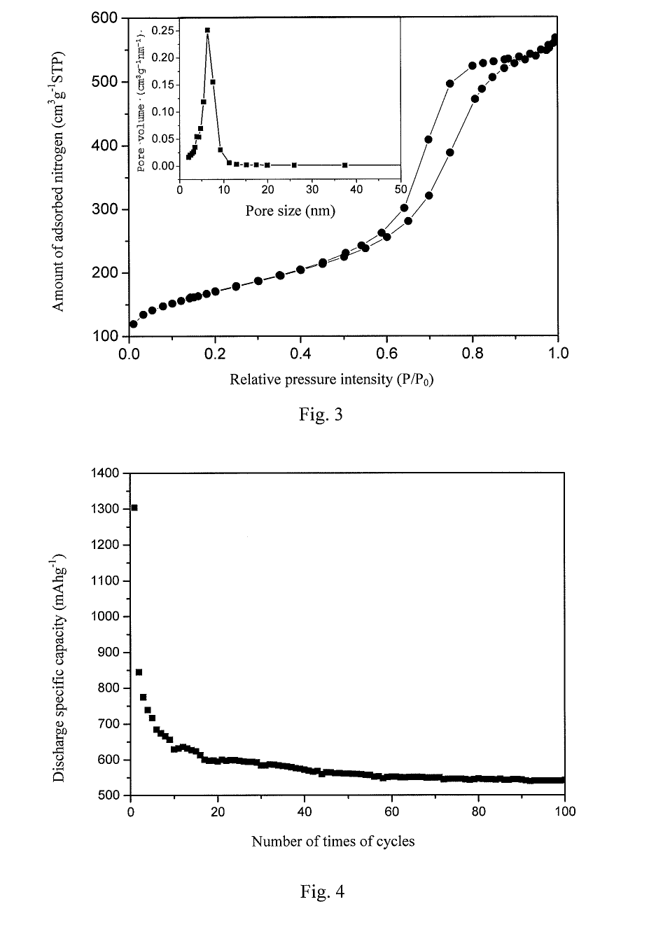

The dispersion was subjected to hydrothermal treatment at 180° C. for 4 h, subjected to centrifugal separation, washing, and drying, and then heat-treated at 500° C. for 4 h in a nitrogen gas atmosphere. The heat-treated material was dispersed in 80 mL of a 2 mol/L aqueous sodium hydroxide solution. The dispersion was stirred for 12 h, subjected to centrifugal separation, washing, and drying, and then subjected to heat-treatment at 700° C. for 4 h in a nitrogen gas atmosphere to thereby obtain a tin/carbon mesoporous composite for a lithium ion battery negative electrode material. As apparent from plasma emission spectroscopy analysis, the content of tin in the obtained tin/carbon mesoporous composite for a lithium ion battery negative electrode material was 37.2 wt. %. FIG. 1 shows a transmission electron microscope photograph of the obtained tin/carbon mesoporous composite for a lithium ion battery negative electrode material. As shown in the drawing, the tin/carbon mesoporous composite for a lithium ion battery negative electrode material had a two-dimensional hexagonal regular mesoporous structure, and the particle size thereof was about 6 nm. FIG. 2 shows X-ray diffraction patterns, and as apparent from the analysis, the obtained tin/carbon mesoporous composite for a lithium ion battery negative electrode material was pure β-Sn, containing no impurities such as SnO₂ or SnO, and this tin/carbon mesoporous composite for a lithium ion battery negative electrode material had a regular mesoporous structure. FIG. 3 shows a nitrogen adsorption curve, and as apparent from the analysis, the obtained tin/carbon mesoporous composite for a lithium ion battery negative electrode material had an average pore size of 6.3 nm and a specific surface area of 583 m²·g⁻¹.

The tin/carbon mesoporous composite powder as an active material, acetylene black as a conductive agent, and polyvinylidene fluoride as a binder were uniformly mixed at a weight ratio of 8:1:1, and then the mixture was applied to copper foil to thereby produce an electrode piece. In a dry glove box under an argon gas atmosphere, a 2016-type button battery was assembled using a metallic lithium piece as a counter electrode, a GF/A film as a diaphragm, and ethylene carbonate (EC) +dimethyl carbonate (DMC)+LiPF₆ as an electrolyte solution, and its performance was tested. The voltage range for measuring the battery was 0.01 V to 3.0 V; the electrolyte solution was 1 mol/L of LiPF₆/EC:DMC (volume ratio 1:1); the counter electrode was a metallic lithium piece; the current density for testing on the constant current charge and discharge was 500 mA·g⁻¹; and test temperature was 25±2° C. FIG. 4 is a diagram showing the cycle characteristics of a lithium ion battery assembled using the obtained tin/carbon mesoporous composite for a lithium ion battery negative electrode material as an electrode material. As shown in this diagram, the discharge specific capacity of the assembled lithium ion battery was maintained at 550 mAh·g⁻¹, and it showed excellent electrochemical cycle performance.

1. A tin-carbon composite comprising: mesopores.

2. The tin-carbon composite according to claim 1, wherein the mesopores are formed as a honeycomb structure.

3. The tin-carbon composite according to claim 1, wherein the pore size of the mesopores is 30 nm or less.

4. The tin-carbon composite according to claim 1, wherein the particle size of tin is three times or less of the mesopore size.

5. A lithium ion battery negative electrode component comprising the tin-carbon composite according to claim 1.

6. A lithium ion battery comprising the negative electrode component according to claim 5.

7. A method for producing a tin-carbon composite having mesopores, the method comprising:
providing a mesoporous molecular sieve as a template;
filling mesopores of the template with a stannous halide and a soluble resole resin having a molecular weight of 300 to 500 followed by carbonization in an inert gas atmosphere to obtain a stannic oxide/carbon composite in which the stannic oxide is covered with the carbon;
subjecting the resulting composite to hydrothermal treatment in a polyhydroxy aldehyde solution, separation, washing, and drying followed by carbonization again to cover the stannic oxide nanoparticles exposed to the outside of the carbon in the mesopores and cover the external surface of the mesoporous molecular sieve with one layer of carbon;
removing the template with an alkaline solution; and
reducing the stannic oxide to metallic tin by high-temperature treatment to obtain a tin-carbon composite having mesopores.

8. The production method according to claim 7, wherein the stannous halide, the soluble resole resin, and the mesoporous molecular sieve are mixed in a weight ratio of 1:0.5 to 5:0.5 to 5.

9. The tin composite according to claim 1, wherein tin is covered by carbon.

10. The tin-carbon composite according to claim 1, wherein tin is pure β-Sn.
